(19) United States
(12) Patent Application Publication
(10) Pub. No.: US 2008/0020107 A1
(43) Pub. Date: Jan. 24, 2008

(54) Method for controlling Kimchi fermentation in Kimchi refrigerator

(75) Inventor: Yoon Hee Park, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/727,015

(22) Filed: Mar. 23, 2007

(30) Foreign Application Priority Data
Jul. 21, 2006 (KR) 10-2006-0068710

(51) Int. Cl. G05D 23/19

(52) U.S. Cl. 426/231

(57) ABSTRACT

A method for controlling fermentation of Kimchi in a Kimchi refrigerator includes a pre-fermentation step of preserving the Kimchi for a first specific time period until an initial temperature of the Kimchi in the Kimchi refrigerator reaches a specific level suitable for a Kimchi fermentation; a fermentation step of fermenting the Kimchi for a second specific time period at a specific temperature to activate lactic acid bacteria of the Kimchi in the Kimchi refrigerator; a cooling step of cooling the fermented Kimchi rapidly for a third specific time period so as to prevent the Kimchi fermented in the Kimchi fermentation step from being over-fermented; and a preservation step of preserving the Kimchi at another specific temperature to preserve the Kimchi cooled rapidly for preservation.

### FIELD OF THE INVENTION

The present invention relates to a method for controlling Kimchi fermentation in a Kimchi refrigerator, and more specifically, to a method for controlling Kimchi fermentation in a Kimchi refrigerator, the method being capable of preliminarily preserving the Kimchi at an optimum temperature to ferment the Kimchi without having to account for an initial temperature of the Kimchi preserved in the refrigerator and then fermenting the Kimchi so as to achieve a rich and cool taste of the Kimchi.

### BACKGROUND OF THE INVENTION

In general, a Kimchi refrigerator is a home appliance for preserving and fermenting Kimchi by using refrigeration cycles, while allowing the Kimchi to be suitably fermented according to user's preference and then preserved for an extensive period time by maintaining it under a suitable temperature.

Such a Kimchi refrigerator is designed to preserve the Kimchi under a specific temperature so as to preserve its genuine taste even for a long time, or to input various patterns configured to ferment, within a specific time period, the preserved.

However, in accordance with a fermentation control method in a conventional Kimchi refrigerator, when the Kimchi is put thereinto and preserved in a fermentation mode, it is customarily fermented without considering an initial temperature of the Kimchi to be preserved.

Accordingly, in case an initial temperature of the Kimchi is lower than the temperature predetermined for fermentation, the Kimchi being put into the Kimchi refrigerator, the fermentation mode is terminated even before the Kimchi can be completely fermented, thereby failing to ferment the Kimchi to the user's desired level. Whereas, in case an initial temperature of the Kimchi put into the Kimchi refrigerator is higher than the temperature predetermined for fermentation, the Kimchi is completely fermented even before the fermentation mode is terminated, thereby over-fermentating the Kimchi.

### SUMMARY OF THE INVENTION

It is, therefore, an object of the present invention to provide a method for controlling Kimchi fermentation in a Kimchi refrigerator, capable of fermenting the Kimchi at an optimum temperature without having to account for an initial temperature of the Kimchi put into the Kimchi refrigerator by preparing a separate pre-fermentation step before the temperature of Kimchi reaches a fermentation level.

In accordance with the present invent invention, there is provided a method for controlling fermentation of Kimchi in a Kimchi refrigerator, including: a pre-fermentation step of preserving the Kimchi for a first specific time period until an initial temperature of the Kimchi in the Kimchi refrigerator reaches a specific level suitable for a Kimchi fermentation; a fermentation step of fermenting the Kimchi for a second specific time period at a specific temperature to activate lactic acid bacteria of the Kimchi in the Kimchi refrigerator; a cooling step of cooling the fermented Kimchi rapidly for a third specific time period so as to prevent the Kimchi fermented in the Kimchi fermentation step from being over-fermented; and a preservation step of preserving the Kimchi at another specific temperature to preserve the Kimchi cooled rapidly for preservation.

### BRIEF DESCRIPTION OF THE DRAWINGS

The above and other objects and features of the present invention will become apparent from the following description of embodiments given in conjunction with the accompanying drawings, in which:

FIG. 1 is a graph of temperature and time of Kimchi, where the steps of a method for controlling Kimchi fermentation in a Kimchi refrigerator are shown in accordance with the present invention; and

FIG. 2 is a block diagram illustrating the steps of a method for controlling Kimchi fermentation in a Kimchi refrigerator in accordance with the present invention.

### DETAILED DESCRIPTION OF THE EMBODIMENTS

Hereinafter, embodiments of the present invention will be described in detail with reference to the accompanying drawings so that they can be readily implemented by those skilled in the art.

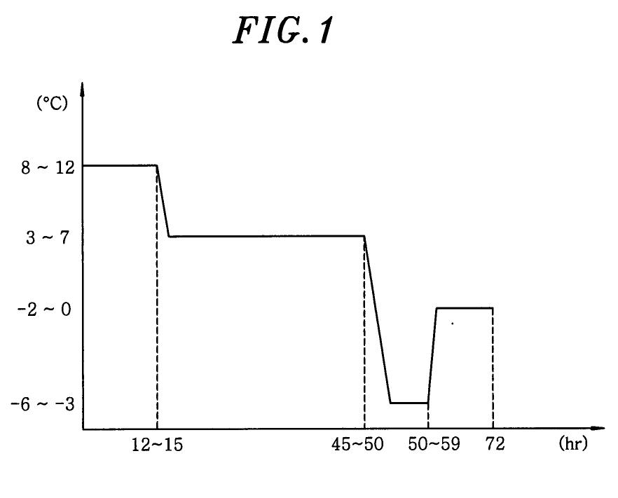

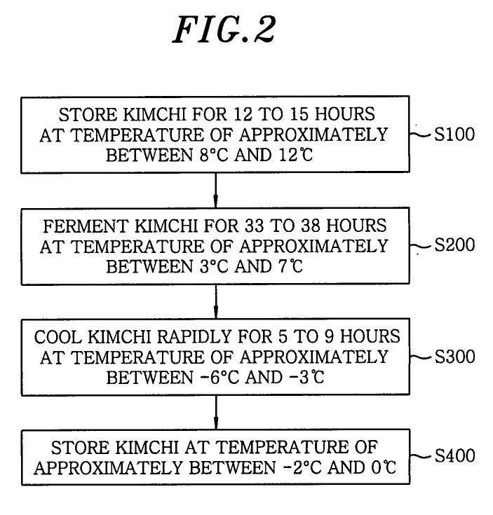

FIG. 1 is a graph of temperature and time of Kimchi, where the steps of a method for controlling Kimchi fermentation in a Kimchi refrigerator are shown in accordance with the present invention; and FIG. 2 is a block diagram illustrating the steps of a method for controlling Kimchi fermentation in a Kimchi refrigerator in accordance with the present invention.

In general, an initial temperature of Kimchi is different depending on the Kimchi preserved in the Kimchi refrigerator. That is, the initial temperature is typically set in a range of 5° C. to 15° C. for preserving matured Kimchi, normally 20° C. for Kimchi prepared at an indoor environment, and typically −1° C. for Kimchi preserved in the Kimchi refrigerator.

As described above, as for a method for storing and fermenting the Kimchi whose initial temperature is different depending on its kind preserved in the Kimchi refrigerator, a method for fermenting the Kimchi at an optimum temperature at all times, without having to account for the kind of Kimchi having a different initial temperature, by using the following steps is provided in accordance with the present invention.

At first, a pre-fermentation step is performed, where the Kimchi put into the Kimchi refrigerator is preserved for a specific time allowing an initial temperature of the Kimchi to reach a level suitable for a Kimchi fermentation (S100).

More specifically, in the pre-fermentation step, the Kimchi is preserved at approximately between 8° C. and 12° C. for 12 to 15 hours, preferably, at 10° C. for 12 hours so that temperature of the Kimchi can reach a level optimized for entering a Kimchi fermentation step, the next step.

Next, a Kimchi fermentation step is performed, where the Kimchi is fermented at a temperature suitable for entering lactic acid bacteria of the Kimchi put into the Kimchi refrigerator (S200).

More specifically, the Kimchi is fermented at the temperature approximately between 3° C. and 7° C. for 33 to 38 hours, preferably, at 5° C. for 36 hours in the Kimchi fermentation step.

In general, when the Kimchi is at the temperature of approximately between 5° C. and 15° C., micrococci, i.e., Leuconostic species, first proliferate. When the PH concentration of the Kimchi is reduced to 5.6 to 4.5 to become acid, i.e., when the Kimchi turns sour and its temperature rises after a specific time, the Leuconostic species disappear and then bacilli, that is, Lactobacillus species proliferate, so that its PH level is normally reduced to approximately 3.8.

That is, when the temperature of the Kimchi is 15° C. or less, the number of bacilli, that is, Leuconostic species which gives a rich and cool taste of Kimchi is increased. Further, when the temperature of the Kimchi is higher than 15° C., the number of Lactobacillus species which gives well-fermented taste is increased.

Accordingly, the temperature of approximately 15° C. for Kimchi is a critical one at which the lactic acid bacteria of the Kimchi can be increased to a maximum and at which the micrococci (Leuconostic species) and bacilli (Lactobacillus species) are present in similar amount.

Accordingly, as described above, the initial temperature of the Kimchi is changed to a level optimized for fermenting the Kimchi in the Kimchi refrigerator in a pre-fermentation step and then the Kimchi is fermented in the Kimchi fermentation step, so as to achieve a rich and cool taste of Kimchi.

Next, a rapid cooling step is performed where the fermented Kimchi is rapidly cooled for a specific time in order to prevent the Kimchi from being over-fermented (S300).

More specifically, in the rapid cooling step, the Kimchi is rapidly cooled at the temperature of approximately between −6° C. and −3° C. for 5 to 9 hours, preferably, at the temperature of −6° C. for 7 hours so as to stop the Kimchi from fermenting any longer.

Finally, after the rapid cooling step, a Kimchi preservation step is performed where the Kimchi cooled rapidly is preserved at a specific temperature in order to preserve the Kimchi for an extensive period of time (S400).

More specifically, in the Kimchi preservation step, the Kimchi, which is completely fermented after going through all of the former steps, is preserved at the temperature of approximately between −2° C. and 0° C., preferably, at the temperature of −1° C. in order to preserve it for a long time without changing its own taste.

As described above, the method for controlling Kimchi fermentation in the Kimchi refrigerator in accordance with the present invention includes the Kimchi pre-preservation step of preliminarily preserving the Kimchi at the optimized temperature for fermenting the Kimchi, the Kimchi fermentation step of fermenting the Kimchi whose temperature reached the optimized level in the pre-fermentation step, the rapid cooling step of cooling the Kimchi fermented in the Kimchi fermentation step so as to prevent the Kimchi from fermenting any longer, and the Kimchi preservation step of preserving the Kimchi at a specific temperature to preserve the rapidly cooled Kimchi for a long time. As a consequence, an ultimate taste can be achieved for the Kimchi.

According to the method for controlling Kimchi fermentation in the Kimchi refrigerator of the present invention described above, the Kimchi is preliminarily preserved at the optimum temperature to activate lactic acid bacteria of the Kimchi without having to account for the initial temperature of the Kimchi in the Kimchi refrigerator by preparing a pre-fermentation step before the Kimchi becomes fermented at a specific temperature, and then the Kimchi is fermented, thereby achieving the ultimate taste of the Kimchi.

While the invention has been shown and described with respect to the embodiments, it will be understood by those skilled in the art that various changes and modifications may be made without departing from the spirit and scope of the invention as defined in the following claims.

What is claimed is:

1. A method for controlling fermentation of Kimchi in a Kimchi refrigerator, comprising:
a pre-fermentation step of preserving the Kimchi for a first specific time period until an initial temperature of the Kimchi in the Kimchi refrigerator reaches a specific level suitable for a Kimchi fermentation;
a fermentation step of fermenting the Kimchi for a second specific time period at a specific temperature to activate lactic acid bacteria of the Kimchi in the Kimchi refrigerator;
a cooling step of cooling the fermented Kimchi rapidly for a third specific time period so as to prevent the Kimchi fermented in the Kimchi fermentation step from being over-fermented; and
a preservation step of preserving the Kimchi at another specific temperature to store the Kimchi cooled rapidly for preservation.

2. The method of claim 1, wherein, in the pre-fermentation step, the Kimchi is preserved in a first temperature range of 8° C. to 12° C.

3. The method of claim 2, wherein the Kimchi is preserved for 12 to 15 hours in the first temperature range of 8° C. to 12° C.

4. The method of claim 1, wherein, in the Kimchi fermentation step, the Kimchi is fermented in a second temperature range of 3° C. to 7° C.

5. The method of claim 4, wherein the Kimchi is fermented for 33 to 38 hours in the second temperature range of 3° C. to 7° C.

6. The method of claim 5, wherein, in the rapid cooling step, the Kimchi is cooled rapidly in a third temperature range of −6° C. to −3° C.

7. The method of claim 6, wherein the Kimchi is cooled rapidly for 5 to 9 hours in the third temperature range of −6° C. to −3° C.

8. The method of claim 1, wherein, in the Kimchi preservation step, the Kimchi is preserved in a forth temperature range of −2° C. to 0° C.
